(19) United States
(12) Patent Application Publication
(10) Pub. No.: US 2013/0132232 A1
(43) Pub. Date: May 23, 2013

(54) System And Method For Digital Rights Management With Delegated Authorization For Content Access

(71) Applicants: Florian Pestoni, Mountain View, CA (US); Pritham Shetty, Los Altos, CA (US); Sunil C. Agrawal, Milpitas, CA (US); Katherine K. Nadell, San Jose, CA (US)

(72) Inventors: Florian Pestoni, Mountain View, CA (US); Pritham Shetty, Los Altos, CA (US); Sunil C. Agrawal, Milpitas, CA (US); Katherine K. Nadell, San Jose, CA (US)

(21) Appl. No.: 12/545,578

(22) Filed: Aug. 21, 2009

Related U.S. Application Data
(60) Provisional application No. 61/171,730, filed on Apr. 22, 2009.

(51) Int. Cl. G06Q 50/00; G06Q 30/00; G06F 21/00

(52) U.S. Cl. 705/26.25; 726/28

(57) ABSTRACT

Various embodiments of a system and method for digital rights management with delegated authorization for content access are described. Such embodiments may include a runtime component configured to receive protected content. The runtime component may be configured to submit a request for a delegation token to a first entity, such as a content merchant or some other entity. The runtime component may be configured to receive the delegation token from the first entity. The runtime component may also be configured to submit a request for a content license for the protected content to a second entity, such as an access coordinator or some other entity. The submitted request may include the received delegation token. The runtime component may be configured to receive the content license from the second entity. The runtime component may also be configured to provide access to the protected content in accordance with the received content license.

### PRIORITY INFORMATION

This application claims benefit of priority to U.S. Provisional Patent Application No. 61/171,730 filed Apr. 22, 2009 titled “System and Method for Digital Rights Management with Delegated Authorization for Content Access” which is hereby incorporated by reference herein in its entirety.

### BACKGROUND

1. Field of the Invention

The present invention is directed to computer systems. More particularly, it is directed to digital rights management within a computing environment.

2. Description of the Related Art

The Internet, sometimes called simply “the Net,” is a worldwide system of computer networks in which a client at any one computer may, with permission, obtain information from any other computer. The most widely used part of the Internet is the World Wide Web, often abbreviated “WWW,” which is commonly referred to as “the web.” The web may include all the resources (e.g., web pages and web sites) and users on the Internet that use the Hypertext Transfer Protocol (HTTP) or variations thereof to access the resources. In some cases, a web site is a related collection of web files that includes a beginning file called a home page. From the home page, the user may navigate to other web pages on the web site. A web server program may include a program that, using the client/server model and HTTP, serves the files that form the web pages of a web site to the web users, whose computers contain HTTP client programs (e.g., web browsers) that forward requests and display responses. A web server program may host one or more web sites.

In prior years it would not be uncommon for an individual to obtain content (e.g., literary works, periodicals, music, and movies) from a retail location in the form of a physical medium. For example, an individual might travel to a local bookstore and purchase written works in the form of a book, newspaper, or magazine. In another example, an individual might purchase music stored on a Compact Disc (CD) or a motion picture stored on a Digital Video Disc (DVD). In recent years the ubiquity of the Internet and the World Wide Web has paved the way for alternative methods of obtaining and consuming content. For example, a user might log on to a music retailer's website and download a digital version of a music album. In other example, a user might log on to a movie subscription provider's website to download or stream a motion picture to view on a personal computer. In the case of books, a user might log on to a bookseller's website and download an electronic book (“e-book”) for view on a computer system, such as a desktop computer or a handheld e-book reader.

The Internet and World Wide Web serve as a backbone for numerous file sharing mechanisms. Examples of such mechanisms include electronic mail (“email”) and more advanced file distribution software, such as peer-to-peer (“P2P”) file sharing applications. In many cases, such file sharing mechanisms are often utilized to distribute electronic content to individuals that are not authorized to access such content. Such distribution is likely due in part to the relative ease and anonymity of sharing files through such mechanisms. To combat unauthorized consumption of content, some content owners have adopted an approach to protecting their content known as digital rights management (“DRM”), which may include various techniques for limiting access of electronic content to authorized individuals.

### SUMMARY

Various embodiments of a system and method for digital rights management with delegated authorization for content access are described. Such embodiments may include a runtime component configured to receive protected content, such as video, audio, text or some other type of electronic content. The runtime component may be configured to submit a request for a delegation token to a first entity, such as a content merchant or some other entity. The runtime component may be configured to receive the delegation token from the first entity. The runtime component may also be configured to submit a request for a content license for the protected content to a second entity, such as an access coordinator or some other entity. The submitted request may include the received delegation token. The runtime component may be configured to receive the content license from the second entity. The runtime component may also be configured to provide access to the protected content in accordance with the received content license.

Various embodiments may also include a license server configured to receive a request for a content license for protected content; such request may include a delegation token, such as the delegation token described above with respect to the runtime component. The license server may be configured to perform a verification process to determine whether the delegation token was issued by a trusted entity. The license server may also be configured to, in response to verifying that the delegation token was issued by a trusted entity, provide the content license for consuming the protected content.

### BRIEF DESCRIPTION OF THE DRAWINGS

FIG. 1 illustrates a logical representation of the various elements of the system and method for digital rights management with delegated authorization for content access, according to various embodiments.

FIG. 2 illustrates a flowchart of an exemplary method of the system and method for digital rights management with delegated authorization for content access, according to various embodiments.

FIG. 3 illustrates a flowchart of another exemplary method of the system and method for digital rights management with delegated authorization for content access, according to various embodiments.

FIG. 4 illustrates a block diagram of one example of a system configuration, according to various embodiments.

FIG. 5 illustrates an example computer system configured to implement various elements of the system and method for digital rights management with delegated authorization for content access, according to various embodiments.

While the system and method for digital rights management with delegated authorization for content access is described herein by way of example for several embodiments and illustrative drawings, those skilled in the art will recognize that the system and method for digital rights management with delegated authorization for content access is not limited to the embodiments or drawings described. It should be understood, that the drawings and detailed description thereto are not intended to limit embodiments to the particular form disclosed. Rather, the intention is to cover all modifications, equivalents and alternatives falling within the spirit and scope of the system and method for digital rights management with delegated authorization for content access as defined by the appended claims. Any headings used herein are for organizational purposes only and are not meant to limit the scope of the description or the claims. As used herein, the word “may” is used in a permissive sense (i.e., meaning having the potential to), rather than the mandatory sense (i.e., meaning must). Similarly, the words “include”, “including”, and “includes” mean including, but not limited to. In various portions of the description presented herein, the terms “validate”, “verify”, “validation”, “verification”, “validating”, and “verifying” may be used interchangeably.

### DETAILED DESCRIPTION OF EMBODIMENTS

Various embodiments of a system and method for digital rights management with delegated authorization for content access are described. In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Some portions of the detailed description which follow are presented in terms of algorithms or symbolic representations of operations on binary digital signals stored within a memory of a specific apparatus or special purpose computing device or platform. In the context of this particular specification, the term specific apparatus or the like includes a general purpose computer once it is programmed to perform particular functions pursuant to instructions from program software. Algorithmic descriptions or symbolic representations are examples of techniques used by those of ordinary skill in the signal processing or related arts to convey the substance of their work to others skilled in the art. An algorithm is here, and is generally, considered to be a self-consistent sequence of operations or similar signal processing leading to a desired result. In this context, operations or processing involve physical manipulation of physical quantities. Typically, although not necessarily, such quantities may take the form of electrical or magnetic signals capable of being stored, transferred, combined, compared or otherwise manipulated. It has proven convenient at times, principally for reasons of common usage, to refer to such signals as bits, data, values, elements, symbols, characters, terms, numbers, numerals or the like. It should be understood, however, that all of these or similar terms are to be associated with appropriate physical quantities and are merely convenient labels. Unless specifically stated otherwise, as apparent from the following discussion, it is appreciated that throughout this specification discussions utilizing terms such as “processing,” “computing,” “calculating,” “determining” or the like refer to actions or processes of a specific apparatus, such as a special purpose computer or a similar special purpose electronic computing device. In the context of this specification, therefore, a special purpose computer or a similar special purpose electronic computing device is capable of manipulating or transforming signals, typically represented as physical electronic or magnetic quantities within memories, registers, or other information storage devices, transmission devices, or display devices of the special purpose computer or similar special purpose electronic computing device.

### INTRODUCTION

Various embodiments of a system and method for digital rights management with delegated authorization for content access are described. Various embodiments may include a digital rights management (DRM) framework configured to provide access to protected content (e.g., content protected with usage rights) in response to the successful completion of a DRM verification process. As described in more detail below, such DRM verification process may include the coordinated efforts of multiple systems including a system on which the consumption of content is attempted as well as a license server system configured to provide content licenses required for the consumption of protected content. In various embodiments, various portions of the aforesaid DRM verification process may be “delegated” to systems other than the license server system and the system on which content is to be consumed. In one particular example, the verification of a valid content subscription (or valid content ownership) may be implemented by a delegation token server (or simply “token server”) separate and distinct from the license server. In various embodiments, the delegation token server may operate under the control and/or ownership of an entity distinct from the entity controlling the license server.

In various instances, this detailed description may refer to content (which may also be referred to as “content data,” “content information” or simply “data” or “information”). In general, content may include any information or data that may be licensed to one or more individuals (or other entities, such as business or group). In various embodiments, content may include electronic representations of video, audio, text and/or graphics, which may include but is not limited to electronic representations of videos, movies, or other multimedia, which may include but is not limited to data files adhering to Adobe® Flash® Video (.FLV) format or some other video file format whether such format is presently known or developed in the future.

In various embodiments, content may include electronic representations of music or other audio, which may include but is not limited to data files adhering to the MPEG-1 Audio Layer 3 (.MP3) format, Adobe® Sound Document (.ASND) format or some other format configured to store electronic audio whether such format is presently known or developed in the future. In some cases, content may include data files adhering to the following formats: Portable Document Format (.PDF), Electronic Publication (.EPUB) format created by the International Digital Publishing Forum (IDPF), JPEG (.JPG) format, Portable Network Graphics (.PNG) format, Adobe® Photoshop® (.PSD) format or some other format for electronically storing text, graphics and/or other information whether such format is presently known or developed in the future. In some embodiments, content may include any combination of the above-described examples.

In various instances, this detailed disclosure may refer to consuming content or to the consumption of content, which may also be referred to as “accessing” content, “viewing” content, “listening” to content, or “playing” content, among other things. In some cases, the particular term utilized may be dependent on the context in which it is used. For example, consuming video may also be referred to as viewing or playing the video. In another example, consuming audio may also be referred to as listening to or playing the audio.

In various instances, this detailed description may refer to a device on which content may be consumed. In various embodiments, such a device may include but is not limited to a computing system (e.g., a desktop or laptop computer), a digital audio or multimedia player (e.g., an MP3 player), a personal digital assistant (PDA), a mobile phone, a smartphone, an e-book reader, a digital photo frame, or any other device or system configured to access, view, read, write, and/or manipulate any of the content data described herein.

Note that in various instances the description presented herein may refer to a given entity performing some action. It should be understood that this language may in some cases mean that a system (e.g., a computer system) owned and/or controlled by the given entity is actually performing the action.

### DRM Framework Participants

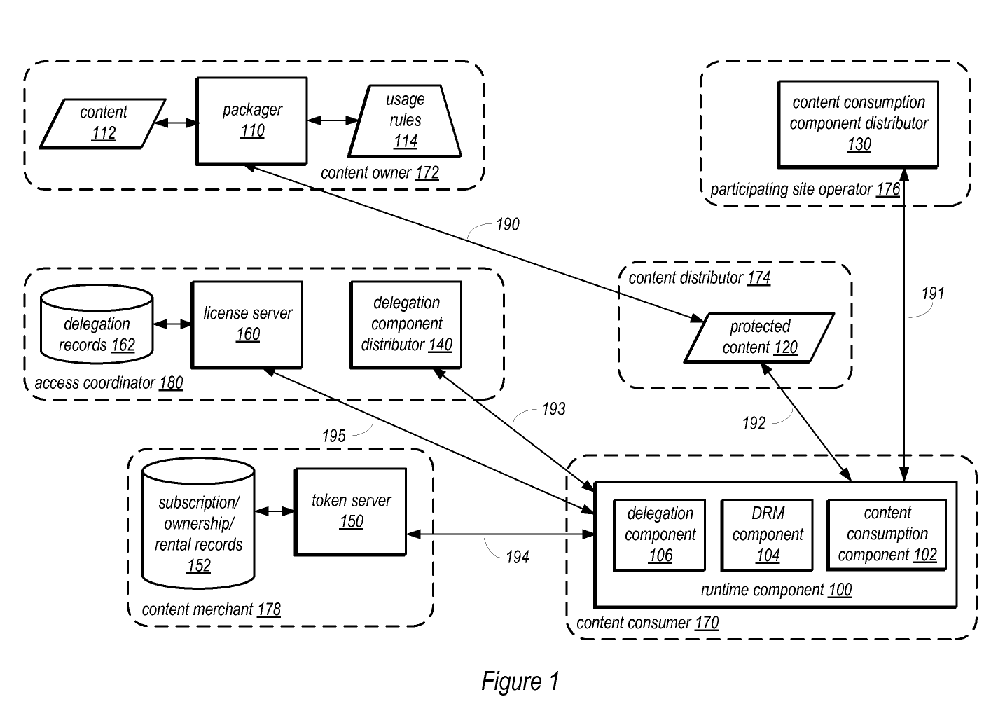

FIG. 1 illustrates a logical representation of a DRM framework with delegated authorization for content access, the operation of which is described in more detail herein below. In various embodiments, various entities may own or control various components of the illustrated framework. For instance, FIG. 1 illustrates a plurality of “domains” 170-180, each of which represent an entity that owns and/or controls the elements within that domain. Note that the illustrated embodiment is not intended to limit other possible implementations of such domains. For instance, in some embodiments, various elements of FIG. 1 may operate in domains structured differently than those illustrated. In some cases each domain may be distinct from each other domain. In other cases, at least some of the domains may represent the same entity. For instance, in one particular example content owner 172 and access coordinator 180 may represent the same entity.

In some embodiments, content owner 172 may represent an entity that owns or controls content 112, an example of which includes an entity that owns rights to such content (e.g., copyrights or other intellectual property rights). In one particular example, content owner 172 may represent a premium content provider that provides such content to content merchants in exchange for licensing fees. For instance, the content owner might produce content (e.g., episodes of a television series) and license such content to a content merchant (e.g., a cable or satellite television programming provider) that distributes the content to retail customers.

One example of a content merchant is illustrated as content merchant 178. Content merchant 178 may in some cases be an entity that provides content to consumers in a manner not illustrated in FIG. 1. For instance, content merchant 178 may be a “linear programming” provider. Examples of linear programming include cable or satellite television programs (e.g., television shows or movies). Typically such content may be accessed with a television and in some cases an appropriate set top box (e.g., a cable or satellite tuner). Linear programming may derive its name from the manner in which it delivers programs, namely in a serial or “linear” fashion (e.g., a given program follows the conclusion of another program, a subsequent program follows the conclusion of the given program, and so on). For example, to consume content, a consumer might tune to a particular channel to view various types of television programming. Note that content merchant 178 is not limited to linear programming. For instance, instead of providing programming according to a substantially set schedule, content merchant 178 might provide content in an “on-demand” fashion. For instance, consumers might select from a menu a particular program that can be consumed immediately. One example might include a pay-per-view movie sold in an on-demand fashion.

Note that the above described process for content delivery provided by the content merchant may occur separately from the content delivery in the illustrated DRM framework of FIG. 1. For example, a consumer might purchase a subscription (e.g., a monthly subscription or a subscription of some other period of time) for content (e.g., television programming). In other cases, consumers might rent or lease content from the content merchant 178 (e.g., a pay-per-view movie available to be viewed for 24 hours).

Also note that content merchant 178 is not limited to a television programming provider (e.g., cable or satellite television programming providers) or any other type of provider, according to various embodiments. For example, content merchant 178 might be a satellite radio provider that sells subscriptions for audio content (e.g., content provided by radio stations). In general, content merchant 178 may be a merchant that sells content, content subscriptions, or content rentals outside of the framework illustrated in FIG. 1. As described in more detail below, records pertaining to the sale, rental, or subscription of content outside of the illustrated framework may be stored in rental records 152 described in more detail below.

Content consumer 170 may be an entity that attempts to consume protected content (e.g., protected content 120). In one example, content consumer might attempt to download or stream a protected video from the Internet. In various embodiments, content consumer 170 may be a consumer that has purchased content, rented content or subscribed to content provided by content merchant 178; the consumption of that content may be separate from the consumption of protected content 120 in the illustrated embodiment. For example, content consumer 170 might subscribe to and consume cable television provided by content merchant 178 (not illustrated) as well as download protected content 120 for consumption.

As described in more detail below, whether or not a consumer is authorized to consume protected content 120 may in various embodiments depend on whether the consumer has subscribed to (or purchased or rented) content from content merchant 178. For instance, protected content 120 may be an episode of a television drama series downloaded from the Internet (or other networks); such content may be owned by content owner 172. In this example, the consumer may not be able to consume the protected content unless it can be verified that the consumer has purchased a particular subscription from content merchant 178; such particular subscription may be a subscription for content owned by content owner 172 (e.g., a subscription to a premium television channel).

Additional entities may include participating site operator 176, access coordinator 180, and content distributor 174. In various embodiments, participating site operator may be an entity that hosts network-accessible site for accessing protected content. In one embodiment, the participating site operator 176 may be a content owner (such as content owner 172) (e.g., a premium television programming provider), a content merchant (such as content merchant 178) (e.g., a cable or satellite operator), or a third party operator. One example of a third party operator may include an operator of a website that aggregates content from multiple different sources. For instance, such a website might aggregate videos from multiple different content owners as well as individual users. Participating site operators may in some cases enlist the cooperation of a content distributor 174, which may be, e.g., an entity that provides hosting services for the high speed transfer of protected content, such as streaming video. Access coordinator 180 may control license servers (such as license server 160) and delegation component distributors (such as delegation component distributor 140) for multiple content owners and content merchants. Further details about the entities are described in more detail below with respect to the operation of the DRM framework.

### DRM Framework Operation

As illustrated in FIG. 1, a content owner 172 may be configured to utilize a packager 110 to protect content 112. Protecting content 112 may in some embodiments include encrypting the content with an encryption key. In some cases, this may also include digitally signing usage rules 114 and encrypting content 112 to generate protected content that includes such usage rules. In this case, if the protected content is eventually decrypted, the decrypted usage rules can be enforced on the access of the content. Usage rules may include any restrictions on the use or access of the content including but not limited to restricting the access of content to a particular time period, restricting the actions (e.g., view, copy, save, distribute, etc.) that can be performed with respect to the protected content.

In some embodiments, as an alternative to storing usage rules within protected content (or in addition to storing usage rules within the protected content), usage rules may be stored within a content license for the content (described in more detail below). Storing the usage rules within the content license may facilitate creating user-specific usage rules for the same protected content; for instance, different licenses containing different usage rules can be created for different users.

In some embodiments, packager 110 may register usage rules for particular content (indicated by a content identifier) with a metadata service (not illustrated). The usage rules for the content may be obtained later from the metadata service by providing the appropriate content identifier for the content.

The packager 110, or another system controlled by content owner 172, may provide protected content to a content distributor 174, as illustrated by arrow 190. In the illustrated embodiment, such protected content is illustrated as protected content 120. Protected content 120 may in some embodiments be stored within a content distribution network (CDN) operated by content distributor 174. In various embodiments, such CDN may be optimized for the high-speed transfer of data including multi-media content and/or other types of content. In other embodiments, the content owner may provide the content to the participating site owner 176, who may provide the content to the CDN. Note that in various embodiments the content provided to the content distributor is already in protected form. More specifically, the content may be protected (e.g., encrypted) by the content owner (e.g., during the packaging stage) prior to the content owner providing such content to the content distributor. In this way, various embodiments may obviate the need to distribute content keys for content decryption to content distributors. Such techniques may improve security of the content keys (e.g., by not unnecessarily exposing the content keys to third parties) as well as scalability of the system as a whole.

As demonstrated by the illustrated embodiment, content consumer 170 may control a runtime component 100. In various embodiments, runtime component 100 may provide an environment in which additional components may run to perform various functions of the system and method for digital rights management with delegated authorization for content access (e.g., components 102-106, described in more detail below). As described in more detail below, runtime component 100 may in some embodiments obtain such components at runtime (e.g., by downloading them from a remote source). In some embodiments, runtime component 100 may be a component, such as a plug-in or application extension, of an executing application. In one example, runtime component 100 may be a plug-in to a web browser (or other network-based browser). In one particular example, runtime component 100 may be Adobe® Flash® Player.

As illustrated by arrow 191, runtime component 100 may be configured to obtain content consumption component 102 from content consumption component distributor 130. For example, content consumption component 130 may be a component provided by a web server configured to serve web pages to various consumers. For instance, participating site operator 176 may operate a website that provides video content to various users; the participating site operator may enlist a content consumption component distributor 130 to distribute content consumption components to consumer systems, such as the content consumption component 102 provided to runtime component 100. In various embodiments, content consumption component 102 may include executable code or program instructions that may be implemented by runtime component 100. In general, content consumption component may be configured to consume (e.g., access, view, play, etc.) any of the content described herein (e.g., video, audio, multimedia, etc.). In one particular example, content consumption component 102 may be a video consumption component configured to perform various operations for playing video content, such as decoding video content created with various video codecs (e.g., video compression codecs, an example of which includes video codecs utilized to generate Adobe® Flash® Video files) and providing a user interface to control the playing of video content. In one particular example, content consumption component may adhere to the Adobe® Shockwave Flash (SWF) file format.

Note that in various embodiments runtime component 100 may be configured to obtain content consumption component 102 in response to user input. For instance, a user operating a web browser in which runtime component 100 operates may select a hyperlink (or some other control on a web page) that points to content (e.g., a video) that can be consumed with content consumption component 102 (e.g., a video consumption component). In response to such user input, content consumption component distributor 130 may be configured to provide content consumption component 102 to runtime component 100, which may utilize the consumption component to retrieve protected content 120 (described below). In various other embodiments, content consumption component 102 may already be cached by runtime component 100 (e.g., from a previous content access) such that the runtime component does not need to obtain the content consumption component 102 again.

As illustrated by arrow 192, content consumption component 102 may be configured to obtain (e.g., download or stream) protected content 120 from content distributor 174. For instance, if content consumption component 102 were a video consumption component and protected content 120 were video data (e.g., a file adhering to the Adobe® Flash® Video format), the video consumption component may stream video from a CDN operated by the content distributor.

In various embodiments, runtime component 100 and/or content consumption component 102 may determine from which location (e.g., a network location, such as might be indicated by a network address) the protected content is to be retrieved based on information provided by participating site operator 176. For instance, as described above, the content consumption component may be downloaded in response to user input, such as the selection of a hyperlink on a web page served by a web server of the participating site operator 176; the location of the protected content may be indicated by data of that web page or other data provided by the web server. For example, the hyperlink (or other network location) of the protected content may in some cases be the same as the hyperlink whose selection caused the downloading of content consumption component 102. In other embodiments, runtime component 100 and/or content consumption component 102 may determine from which location (e.g., a network location, such as might be indicated by a network address) the protected content is to be retrieved based on information received from the metadata service (not illustrated) mentioned above. For example, the runtime component 100 and/or content consumption component 102 may query the metadata service for the usage rules associated with protected content having a particular content identifier and, in response, receive usage rules or other information that indicates from where the protected content is to be retrieved.

In various embodiments, content consumption component 102 may be configured to determine whether the obtained content is protected content. In response to determining that obtained content is not protected, the content consumption component may be configured to consume (e.g., play or otherwise provide access to the content) the content. In response to determining that the obtained content is protected content (as is the case in the illustrated embodiment), the content consumption component may determine that the protected content may not be consumed until an appropriate license is obtained. In various embodiments, the content consumption component 102 may also be configured to determine whether the protected content is “delegated” content (as is the case in the illustrated embodiment). In various embodiments, delegated content may include content that is designated as requiring the use of a delegated authorization process (described below) when authorizing a user for access to the content. In some embodiments, to determine whether content is protected and/or delegated content, content consumption component 102 may be configured to evaluate metadata of the content that indicates whether the content is protected and/or delegated content. In response to determining that the content is protected content but not delegated content, the content consumption component may proceed with license obtainment and consumption of the content (assuming that a license is successfully obtained).

### DRM Framework Operation—Delegated Authorization for Content Access

In some cases, content consumption component 102 may determine that the protected content obtained is designated to be authorized via a delegated authorization process (e.g., determined based on metadata of the protected content) in order to allow consumption of the content. In various embodiments, instead of relying only on the obtainment of an appropriate content license from a license server, the illustrated framework may authorize a user to access protected content by determining that the user currently has a qualifying content subscription (or content ownership or rental) and, in response to that determination, proceeding with the issuance of a content license. In various embodiments, the issuance of the license may be performed by a first entity and the verification of a qualifying content subscription may be performed by a second entity. In this way, the illustrated DRM framework may enable the first entity to “delegate” a portion of the authorization process to the second entity. For example, a content owner might want to delegate the verification of a qualifying content subscription to the merchant that sold such subscription, which may be the case in the illustrated embodiment. (Note that in the illustrated embodiment access coordinator 180 may handle license issuance on behalf of content owner 172.) For instance, in some cases, a merchant may leverage sales information or user account information to determine whether a particular user is currently subscribed to certain content (or whether the particular user has purchased or rented certain content).

To perform a delegated authorization of the protected content, the content consumption component 102 may be configured to obtain (e.g., download) a delegation component 106 from delegation component distributor 140, as illustrated by arrow 193. In various embodiments, content consumption component 102 may determine the location from which to download the delegation component 106 based on information from the metadata of the protected content. In the illustrated embodiment, the delegation component is obtained from a delegation component distributor 140, which is a system controlled by access coordinator 180. However, in other embodiments, delegation component 140 may be implemented elsewhere, such as on a system of content owner 172 or some other system. In various other embodiments, delegation component 106 may already be cached by content consumption component 102 (e.g., from a previous content access) such that the content consumption component does not need to obtain the delegation component 106 again.

In various embodiments, delegation component 106 may include executable code that may be implemented by runtime component 100 to carry out delegation tasks, as described in more detail below. In various embodiments, the delegation component 106 may include a user-interface (UT) component, which may be configured to receive user credentials, and a non-UT component configured to carry out the acquisition of delegation tokens as well as other tasks to support delegated authorization for content access.

Content consumption component 102 may utilize the UT element of delegation component 106 in order to obtain user credentials from the consumer (i.e., the user). For instance, the UT element might present a dialog box with entry fields for a user name and password or another form of user credentials, such as an account number or personal identification number (PIN). The consumer attempting to access the protected content (i.e., the user of runtime environment 100) may provide such credentials to the UT element of delegation component 106. In other cases, such user credentials may be cached locally (e.g., from a previous content access attempt) and presenting the UT element to obtain the user credentials may be unnecessary (e.g., the content consumption component may access the credentials from the cache instead).

In various embodiments, the UT element may present a list of content merchants and the user may indicate via the UT element one of the content merchants with which the user holds an account. For instance, the list of content merchants might be a list of cable and satellite television operators proximate to the user's location. The user might select one of such operators and provide appropriate credentials for that account. In some cases, the user may not have an account with one of the listed merchants and the UT element may include a mechanism for enabling a user to sign up for an account. For instance, the UT element might include a hyperlink to a webpage for registering and creating an account with a content merchant.

Content consumption component 102 may be configured to communicate with the content merchant for which user credentials were provided. As illustrated by arrow 194, this communication may include a request for a delegation token sent to token server 150, the issuance of which may represent the successful verification of the user having a qualified content subscription (or content ownership or content rental). The request for a delegation token may include the user credentials collected via delegation component 106.

Token server 150 may be configured to utilize the user credentials in the request for the delegation token to determine whether a user has acquired a qualifying content subscription (or qualifying content rental or qualifying content purchase). Information on which to base this determination may be stored within records 152, which may store records of users and any associated subscriptions (or content or rentals) acquired by the user. In one example, if the consumer has a current subscription to a premium television channel, this information may be indicated by a record within records 152. As illustrated by arrow 194, token server 150 may issue a delegation token to delegation component 106 in response to determining records 152 indicate that the consumer does currently have a qualifying subscription with the content merchant. (The token server may deny the issuance of such token in response to determining that records 152 do not indicate that the consumer has acquired such subscription.) In various embodiments, the delegation token described herein may include information or data that indicates a user (e.g., a user of the computer system running runtime component 100) has been authorized to access or consume (e.g., access, play, etc.) the protected content. In various embodiments, the delegation token may also indicate a trusted entity that performed such authorization, such as content merchant 178 or another entity that is different than the entity performing license provisioning (note that in the illustrated example access coordinator 180 performs license provisioning via license server 160). In various embodiments, the delegation token may indicate that merchant 178 (or another entity) determined the user engaged in one or more of: a purchase of the protected content, a rental of the protected content, or a subscription to the protected content (e.g., by checking records 152).

By making the authorization of protected content dependent upon having a valid subscription with the content merchant (as may be the case in the illustrated embodiment) as well as a valid content license, various embodiments may enable content merchants to present the accessing of protected content as a feature available to consumers who acquire such subscriptions. In one example, users that acquire a subscription to a premium television programming channel may be enabled to view related protected content (e.g., on-demand content, bonus content, etc.) on the Internet (or another network). In some cases, this framework may provide consumers with an incentive to acquire and/or maintain subscriptions with the content merchant. Note that while the description presented herein largely refers to determining whether a user has acquired a qualifying subscription, the same principles are applicable to determining whether a user has purchased or rented particular content. For instance, if a user has purchased an audio compact disc (“CD”), they might be provided with access to online content (e.g., downloadable tracks) for that CD. Similarly, if a user has rented a movie for a specific rental time period from the content merchant (e.g., a pay-per-view move offered by the content merchant), the user may be given access to that same movie online during the specific rental time period.

As demonstrated by the illustrated embodiment, runtime component 100 may be configured to utilize a DRM component 104 to acquire a content license from license server 160. One particular example of DRM component 104 includes Adobe® DRM Client for Flash® Player. In various embodiments, DRM component 104 may be configured to generate a request for a content license for protected content 120, as illustrated by arrow 195. This request may include the delegation token as well as other information, such as a content identifier for protected content 120 and/or client credentials (e.g., credentials associated with the consumer or the illustrated components utilized by the consumer). License server 160 may be configured to determine whether the delegation token provided in the license request is a token issued by a trusted entity. License server 160 may utilize delegation records 162 to determine whether the entity that issued the delegation is a trusted entity. For instance, records 162 may include records that indicate whether a participating site operator (which may be a content owner, a content merchant or a third party) trusts the issuer of the delegation token. In one example, license server may be configured to lookup records pertaining to the relevant participating site operator (e.g., participating site operator 176 in the illustrated embodiment) and determine whether any of such records pertain to the issuer of the delegation token (e.g., content merchant 178 in the illustrated embodiment). In response to finding a record that indicates the participating site operator trusts the issuer of the delegation token, the license server may issue a content license for protected content 120 and send the content license to DRM component 104, as illustrated by arrow 195. In some cases, the issuance of the content license by the license server may additionally depend on license server successfully verifying other information (e.g., verifying credentials associated with the consumer or the illustrated components utilized by the consumer).

Note that in various embodiments, the license server need not be implemented by the same entity that controls the delegation component distributor 140. For instance, in other embodiments, a content owner may implement a license server for issuing licenses pertaining to content owned by that content owner.

The content license generated by the license server for the protected content may include a decryption key to decrypt the protected content (which, as described above, may be encrypted by the content owner). The license generated by the license server may also include the usage rules for the protected content, such as usage rules set forth by the content owner or some other usage rules. Such usage rules may include any restrictions on the use or access of the content including but not limited to restricting the access of content to a particular time period, restricting the actions (e.g., view, copy, save, distribute, etc.) that can be performed with respect to the protected content.

In various embodiments, the license server may generate the content license such that it is “bound” to any of the runtime component 100, the content consumption component 102, the DRM component 104, and the delegation component 106 (or the host system implementing such components). Binding a content license to a given component may in various embodiments mean that the license can only be utilized by that component. In one example, any one of the aforesaid components may have its own public key—private key pair; binding a license to a given one of the aforesaid components may include encrypting the content license with that component's public key. In this way, only the component that has access to the corresponding private key may be able to decrypt and utilize the content license, according to various embodiments.

Note that in various embodiments the delegation token may be bound to runtime component 100 (or an associated component or the computer system implementing the runtime component) in a manner similar to that described above with respect to the content license (e.g., the token server may encrypt the delegation token with the public key of the runtime component such that only the runtime component may determine the unencrypted version of the delegation token).

DRM component 104 may be configured to utilize the content license (the receipt of which is illustrated by arrow 195) to enable content consumption component 102 to consume (e.g., play, display, access, etc.) the protected content. In one embodiment, the DRM component may decrypt the protected content with the decryption key from the obtained license. Note that in embodiments where the protected content was symmetrically encrypted by packager 110, the decryption key in the content license may be the same as the encryption key utilized by the packager to encrypt the content. DRM component 104 may also ensure that the usage rules within the content license are enforced. For example, one usage rule might indicate that content may only be accessible for a particular time period; the DRM component may ensure that the content is only accessible during that time period (e.g., by not decrypting the data outside of that time period). Any of the other usage rules described above may also be enforced. DRM component 104 may be configured to provide the unencrypted content (in accordance with any usage rules) to content consumption component 102 for consumption. In one embodiments, the DRM may stream the unencrypted content to the content consumption component (e.g., by streaming the data as it is being encrypted). In other cases, the DRM component may transfer the fully decrypted content to content consumption, such as by transferring a file representing the unencrypted content to the content consumption component (or making such a file available to the content consumption component in some other manner). Content consumption component may consume the content in accordance with the content type. For example, if the unencrypted content is video data, the content consumption component may play the video on a display. In other cases, other types of media (e.g., audio, etc.) may be consumed. In some cases, the consumption of content by the content consumption component may be controlled by a user interface responsive to user input. For example, user input might indicate instructions (e.g., play, pause, stop, next clip/track, etc.) and the content consumption may operate in accordance with those instructions (e.g., by playing, pausing, stopping content, etc.).

### DRM Framework Operation—Secure Communication

In various embodiments, techniques similar to those utilized to bind a license to a component (described above) may provide secure communication between any of the elements of the illustrated framework. For instance, various elements of the illustrated framework may be associated with respective public key—private key pairs, such as key pairs utilized in Public Key Infrastructure (PKI). In the illustrated framework, a first element may securely transfer data to a second element by encrypting that data with the second element's public key. In this manner, only the second element will be able to decrypt the encrypted data to access the unencrypted data, according to various embodiments. For instance, since in various embodiments knowledge of the private key may be required to decrypt the data and since the second element may be the only element that has knowledge of its own private key, the second element may be the only element able to decrypt the data with the correct private key. Note that the aforesaid techniques may in various embodiments be utilized for any transfer of data within the DRM framework. One example includes the “binding” of the license to the runtime component 100 or any of the other components it utilizes. Another example might include token server 150 securely sending a token to delegation component 106. For example, token server might obtain a public key for the delegation component 106 and encrypt the token with that public key prior to transferring the token to the delegation component. In this example, only the delegation component will be able to decrypt the token (since the delegation component may be the only element with knowledge of the correct private key). In some embodiments, a given element may trust another element with knowledge of its private key (thereby allowing the other element to decrypt data encrypted with the given element's public key). For example, content consumption component 102 might share its private key with runtime component 100 (or vice versa). In various embodiments, the public keys described herein may be obtained from a public key certificate, such as a certificate provided by a certificate authority (not illustrated) in PKIs. One example of such a certificate is an X.509 certificate (in other cases, other types of public key certificates may be utilized).

### DRM Framework Operation—Caching

In various embodiments, the illustrated framework may utilize caching to avoid re-obtaining certain data on subsequent content accesses. In one example, the content and/or the delegation component may be cached such that they are already stored locally for use by runtime component 100. In one particular embodiment, the delegation component 106 may be cached for use across different participating sites. For instance, the content consumer might visit a particular content owner's website to view video content owned by that particular content owner. At some later time, the content consumer might visit another website (e.g., a website that aggregates content from multiple content owners) to view video data owned by the same particular content owner. This second website may cause the download of another instance of a content consumption component for the runtime component. In embodiments where a delegation component may be utilized for different content owned by the same content owner, this second content consumption component may utilize the same delegation component obtained by the runtime component for the first website. In this way, the DRM framework may be configured such that multiple participating sites trust delegation components provided by the access coordinator thereby bypassing cross-domain attack prevention mechanisms (such as those frequently found in web browsers). (Cross-domain attack prevention mechanisms typically prevent one website from accessing the cached data of another website.)

### DRM Framework Operation—License Chaining

In various embodiments, the same delegation token may be utilized by the runtime component for multiple portions of content. For instance, a delegation token may represent that a user has a currently valid subscription (e.g., a subscription to a premium content television channel); that delegation token may be used for multiple portions of protected content associated with that subscription (e.g., for example, episodes from different television series associated with the subscription) and/or multiple portions of protected content associated with the same content owner (e.g., multiple portions of protected content created by the same content owner).

In various embodiments, while the same delegation token may be utilized for different portions of protected content, each portion of protected content may be governed by a distinct content license. For example, for a given portion of protected content, DRM component 104 may in various embodiments be configured to provide access to that portion of protected content if and only if both the delegation token for that content and the content license for that content are valid. In this sense, the delegation tokens and the content license may be considered as a license tree whereby the delegation token forms the root license of such tree and the individual content licenses form the leaf license of such tree. Enabling protection of content in the manner described above may be referred to as “license chaining.” Note that in various embodiments, for a given portion of protected content, the license chaining performed by the illustrated framework may operate with a root license (i.e., a delegation token) that is issued by one entity (e.g., access coordinator 180) and a leaf license issued by a different entity (e.g., content merchant 178).

In various embodiments, DRM component 104 may also be configured to periodically check whether a delegation token is still valid and update the token if necessary (e.g., the delegation token may have an expiration date after which the token becomes invalid). For instance, since content subscriptions may expire, the delegation tokens corresponding to such subscriptions may also expire. Accordingly, the DRM component may download an updated token and perform verification of the license chain. In various embodiments, the DRM component may perform this verification without having to renew the individual content licenses; in this way, overhead (e.g., time, network bandwidth, processing power) associated with content license acquisition may be conserved.

In some embodiments, license chaining may be utilized such that the delegation token and the content license may be obtained independently (i.e., the delegation token may be obtained before the content license, or the content license may be obtained before the delegation token). For instance, in some embodiments, the delegation token may have an expiration date/time that specifies when a user's subscription expires (or when their rental period or other content access period expires). The runtime component may receive a leaf license (e.g., a leaf license version of a content license) from the license server; the leaf license may have a pointer or other information that identifies or points to a root license (such pointer may establish that the leaf license and the root license belong to the same license chain). In situations where the license server issues a leaf license that has already expired, the leaf license may still be utilized by the runtime component if the runtime component has obtained a valid root license (i.e., a valid delegation token). In embodiments such as these, the runtime component may be configured to utilize the delegation token (e.g., the private key of the delegation token) to decrypt a content key (e.g., a content key encrypted with the public key corresponding to the aforesaid private key) in the leaf license and use such content key to decrypt the protected content. Also note that in various embodiments utilizing license chaining, the root license (i.e., the delegation token, in some embodiments) may be issued by one entity (e.g., merchant 178) and the leaf license(s) (i.e., the content license, in some embodiments) may be issued by a different entity (e.g., access coordinator 180).

### Additional Embodiments

In some embodiments, when the runtime component is issued a delegation token (see e.g., communications 194 of FIG. 1), the runtime component (or any component thereof) may also receive a corresponding public key—private key pair (e.g., such key pair could be part of the delegation token). In such embodiments, the content license issued to the runtime component may be bound to the delegation token, which may in some embodiments mean that at least a portion of the content license (e.g., the content key of the content license or the entire content license in some cases) is encrypted using the aforesaid public key. In some cases, only runtime components that have been given the aforesaid private key may be capable of decrypting and using the license.

In some embodiments, multiple runtime components may be utilized to perform different processing tasks in order to implement the techniques described above. For instance, runtime component 100 may control the processing (e.g., acquisition and use) of the delegation token and pass along the delegation token to a different runtime component (or a DRM component), which may be configured to control the processing (e.g., acquisition and use) of the content license. In some embodiments, another runtime component may control processing (e.g., consumption) of the corresponding protected content. In this way, various embodiments may take advantage of different features (e.g., security features) of different runtime components. Examples of such features may include phishing prevention capabilities as well as machine individualization, application instance individualization or user individualization.

In some embodiments, certain types of content may not require the acquisition of a content license. In one example, the content acquired by runtime component 100 may be unencrypted yet a portion of the content (e.g., metadata of the content) may specify a requirement that a delegation token be acquired prior to content consumption. Runtime component 100 and/or DRM component 104 may be configured to enforce such a requirement. For instance, if a delegation token is successfully acquired (as described above regarding communications 194), the runtime component (and/or DRM component 104) may permit the consumption of the corresponding content. If a delegation token is not acquired, the runtime component (and/or DRM component) may enforce the aforesaid requirement by prohibiting consumption of the corresponding content.

Note that in various embodiments, some content may require the acquisition of a delegation token but not a content license (e.g., the content may not be encrypted). For instance, the runtime component (or DRM component) may be configure to access usage rules or other information of received content to determine a requirement that specifies a delegation token is to be acquired prior to consuming said content. In response to such determination, the runtime component (or DRM component) may be configured to acquire the appropriate delegation token (the location of which may be specified by the content or metadata of the content) in accordance with any of the techniques described herein. In various embodiments, to enforce the requirement that specifies a delegation token is to be acquired prior to consuming said content, the runtime component (or DRM component) may be configured to provide access to the content if and only if the correct delegation token (as indicated by the content) is successfully acquired and present within memory of the computer system.

### Example Methods

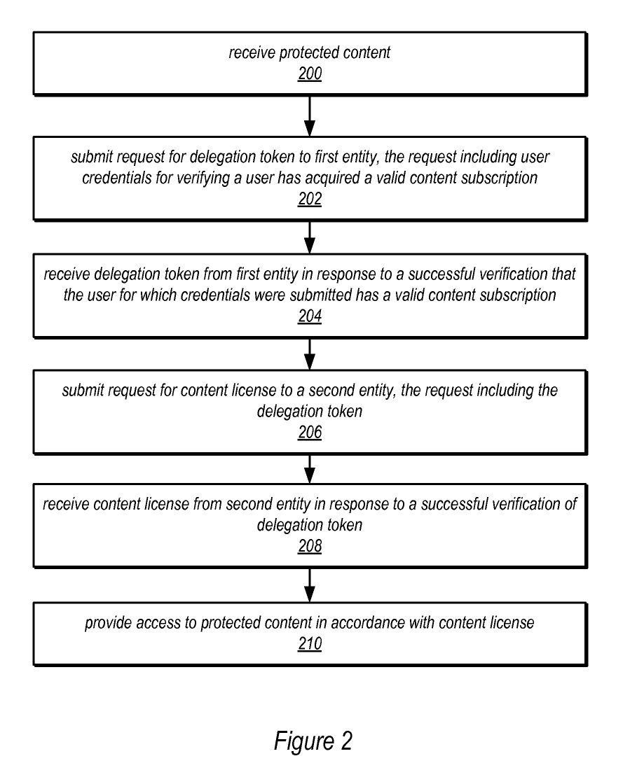

The system and method for digital rights management with delegated authorization for content access may include various methods, examples of which are described below. One example of such method is illustrated by the flowchart of FIG. 2. In various embodiments, the illustrated method may be performed by runtime component 100 described above. As illustrated by block 200, the method may include receiving protected content. Receiving protected content may include receiving any of the protected content described above. For example, receiving protected content might include receiving encrypted video data. In various embodiments, receiving protected content may include receiving protected content from one or more network sources, such as a website or other network source (e.g., a CDN).

As illustrated by block 202, the method may include submitting a request for a delegation token to a first entity (or a computer system owned and/or controlled by that entity). In various embodiments, the request may include user credentials for verification of a valid content subscription. One example of such a request is described above with respect to the request submitted by delegation component 106 to token server 150. In one particular case, an example of a content subscription may include a subscription to a premium television channel.

As illustrated by block 204, the method may also include receiving a delegation token from the first entity (or a computer system owned and/or controlled by that entity) in response to a verification that the user for which the credentials were submitted has a valid (e.g., current) content subscription. For instance, the first entity may evaluate the request submitted at block 202 in manner similar to the way token server 150 evaluates requests for delegation tokens (described above). The method may include receiving a delegation token in response to such an evaluation. In various embodiments of the method, the receipt of a delegation token may represent the successful verification of the user having a valid content subscription (or content ownership or content rental).

As illustrated by block 206, the method may include submitting a request for a content license to a second entity (or a computer system owned and/or controlled by that entity). This request may in various embodiments include the delegation token acquired at block 204. In various embodiments, this request may also include additional information such as a content identifier of the content for which a license is requested and possibly some authentication information. One example of such a request is described in regard to FIG. 1 with respect to the request submitted to license server 160.

As illustrated by block 208, the method may also include receiving a content license (for the protected content) from the second entity (or a computer system owned and/or controlled by that entity) in response to a successful verification of the delegation token. In some cases, such a verification of the delegation token may include verifying that the delegation token was issued by an entity that is trusted by the second entity. In other cases, the second entity may perform such verification on behalf of a third entity (e.g., a content owner); in this case, the verification of the delegation token may include verifying that the delegation token was issued by an entity that is trusted by the third entity. In various embodiments, the method may include receiving a content license that includes a decryption key for decrypting the protected content (which may be encrypted when received at block 200). In some embodiments, the method may include receiving a content license that includes both an encryption key and one or more usage rules specifying restrictions on the consumption of the protected content, such as the usage rules described above with respect to FIG. 1 (e.g., an expiration date after which the content is not to be consumed).

As illustrated by block 210, the method may also include providing access to the protected content in accordance with the received content license. For example, the method may include decrypting the protected content with a decryption from the content license. If the content license also includes usage rules for the protected content, the method may include enforcing such usage rules. In various embodiments, providing access to the protected content may include consuming the content (e.g., playing the content, displaying the content, etc.).

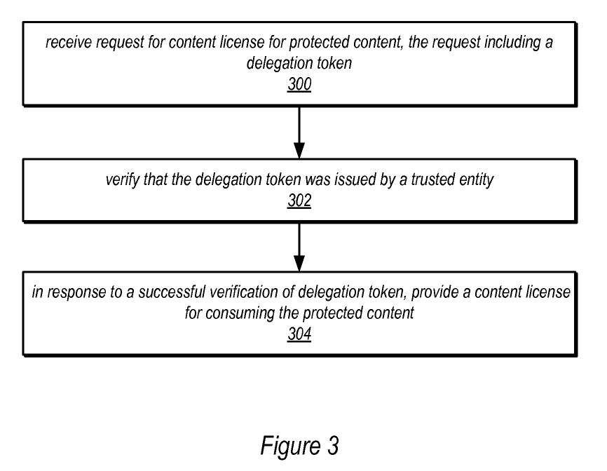

Another example of such method is illustrated by the flowchart of FIG. 3. In various embodiments, the illustrated method may be performed by license server 160 described above. As illustrated by block 300, the method may include receiving a request for a content license for protected content. In various embodiments, the request may include a delegation token, such as any of the delegation tokens described above. In one example, such a delegation token may indicate that a user has a valid subscription for content. In various embodiments, this request may also include additional information such as a content identifier of the content for which a license is requested and possibly some authentication information. One example of such a request is described in regard to FIG. 1 with respect to the request submitted to license server 160.

As illustrated by block 302, the method may include verifying that the delegation token was issued by a trusted entity. Since in various embodiments a delegation token may indicate that a user has a valid subscription for content, verifying that the delegation token was issued by a trusted entity may validate the delegation token (e.g., determine that the token can be trusted). One example of a token issued by a trusted third party is illustrated by the token issued by token server 150 of FIG. 1. In various embodiments, verifying that the delegation component was issued by a trusted entity may include, based on information in the token, determining the issuer of the token and determining whether an associated data store (e.g., delegation records 162, described above) includes a record indicating that the issuer is trusted. If there are no such records, the method may include determining that the token is invalid and thus withhold providing a content license. In the illustrated embodiment, the method may include performing the verification successfully by finding a record that indicates the issuer of the token is a trusted entity.

As illustrated by block 304, the method may also include, in response to a successful verification of the delegation token, providing (or generating) a content license for consuming the protected content. In various embodiments, the method may include providing a content license that includes a decryption key for decrypting the protected content (which may be encrypted). In some embodiments, the method may include providing a content license that includes both an encryption key and one or more usage rules specifying restrictions on the consumption of the protected content, such as the usage rules described above with respect to FIG. 1 (e.g., an expiration date after which the content is not to be consumed).

### Example System Configuration

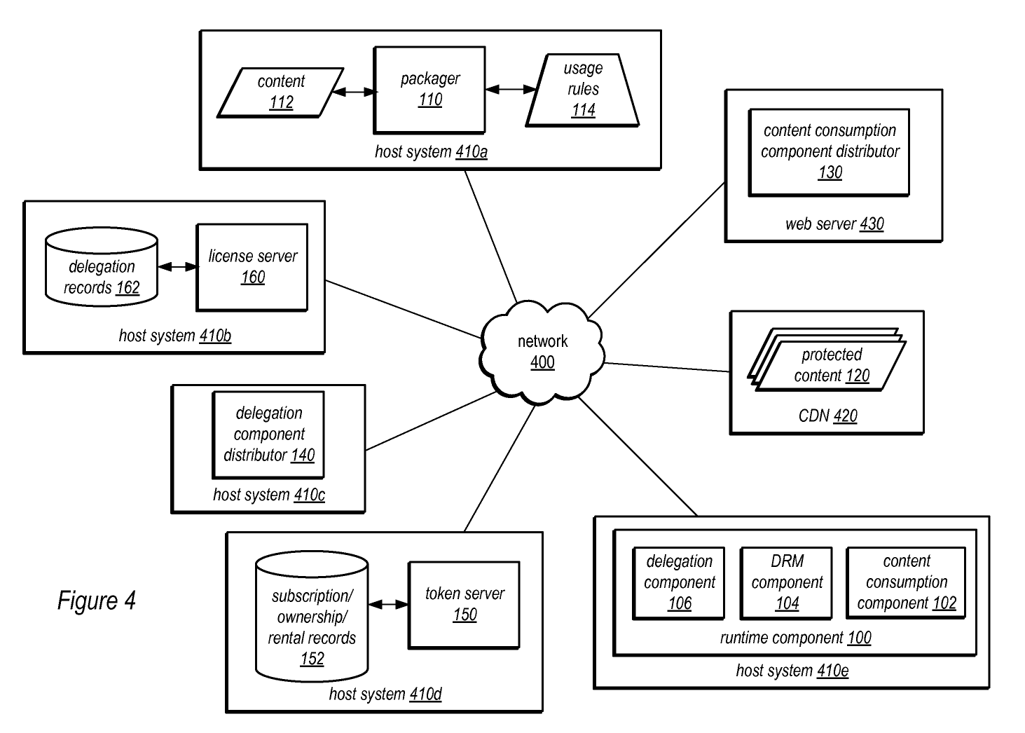

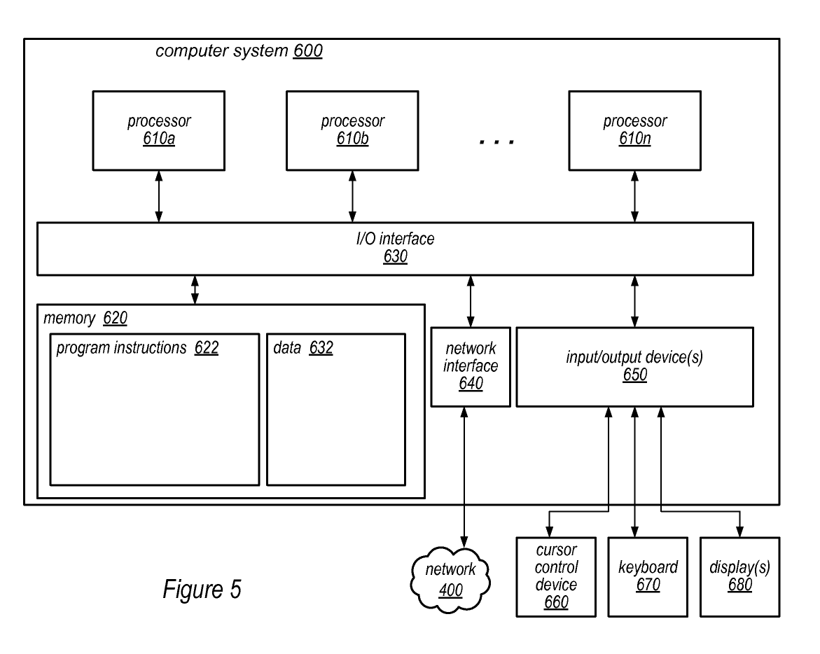

Various embodiments of the system and method for digital rights management with delegated authorization for content access may be configured to different system configurations. One example of such a system configuration is illustrated by the system of FIG. 4. In the illustrated embodiment, each of the elements of the DRM framework described above are implemented as elements of respective computer systems. Each of the illustrated computer systems may in various embodiments communicate via a network, such as network 400. Network 400 may include one or more networks including but not limited to Local Area Networks (LANs) (e.g., an Ethernet or corporate network), Wide Area Networks (WANs) (e.g., the Internet), wireless data networks, some other electronic data network, or some combination thereof. Each given host system of host systems 410a-410e may be a computer system configured to implement the respect components and data illustrated within the given host system via hardware and or software. In addition to host systems 410a-410e, the illustrated embodiment may include a web server 430 (or some other network based server) configured to serve web pages to any of the illustrated host systems (e.g., host system 410e), such as web sites hosting various content protected according to various techniques of the DRM framework. Web server 430 may also be configured to implement content distribution component 130, which may be configured in a manner similar to or the same as that described above with respect to FIG. 1. Additionally CDN 420 may be a content distribution network configured to store various protected content, such as protected content 420. In various embodiments, CDN 420 may be an optimized storage network for delivering high speed streaming (or downloadable) media. Note that any of the systems illustrated in FIG. 4 (e.g., host systems 410a-410e, web server 430, and/or CDN 420) may be implemented via one or more of the computer systems described below with respect to FIG. 5.

### Example Computer System

Various embodiments of a system and method for digital rights management with delegated authorization for content access, as described herein, may be executed on one or more computer systems, which may interact with various other devices. One such computer system is computer system 600 illustrated by FIG. 5, which may in various embodiments implement any of the elements illustrated in FIGS. 1-4. Computer system 600 may be capable of implementing a runtime component or a license server (such as those described above with respect to FIG. 1) which may be stored in memory as processor-executable program instructions. In the illustrated embodiment, computer system 600 includes one or more processors 610 coupled to a system memory 620 via an input/output (I/O) interface 630. Computer system 600 further includes a network interface 640 coupled to I/O interface 630, and one or more input/output devices 650, such as cursor control device 660, keyboard 670, and display(s) 680. In some embodiments, it is contemplated that embodiments may be implemented using a single instance of computer system 600, while in other embodiments multiple such systems, or multiple nodes making up computer system 600, may be configured to host different portions or instances of various embodiments. For example, in one embodiment some elements may be implemented via one or more nodes of computer system 600 that are distinct from those nodes implementing other elements.

In various embodiments, computer system 600 may be a uniprocessor system including one processor 610, or a multiprocessor system including several processors 610 (e.g., two, four, eight, or another suitable number). Processors 610 may be any suitable processor capable of executing instructions. For example, in various embodiments processors 610 may be general-purpose or embedded processors implementing any of a variety of instruction set architectures (ISAs), such as the x66, PowerPC, SPARC, or MIPS ISAs, or any other suitable ISA. In multiprocessor systems, each of processors 610 may commonly, but not necessarily, implement the same ISA.

System memory 620 may be configured to store program instructions 622 and/or data 632 accessible by processor 610. In various embodiments, data 632 may include protected or unprotected content as described above. In various embodiments, system memory 620 may be implemented using any suitable memory technology, such as static random access memory (SRAM), synchronous dynamic RAM (SDRAM), nonvolatile/Flash-type memory, or any other type of memory. In the illustrated embodiment, program instructions and data implementing any of the elements of the DRM framework (as described above), may be stored within system memory 620. In other embodiments, program instructions and/or data may be received, sent or stored upon different types of computer-accessible media or on similar media separate from system memory 620 or computer system 600.

In one embodiment, I/O interface 630 may be configured to coordinate I/O traffic between processor 610, system memory 620, and any peripheral devices in the device, including network interface 640 or other peripheral interfaces, such as input/output devices 650. In some embodiments, I/O interface 630 may perform any necessary protocol, timing or other data transformations to convert data signals from one component (e.g., system memory 620) into a format suitable for use by another component (e.g., processor 610). In some embodiments, I/O interface 630 may include support for devices attached through various types of peripheral buses, such as a variant of the Peripheral Component Interconnect (PCI) bus standard or the Universal Serial Bus (USB) standard, for example. In some embodiments, the function of I/O interface 630 may be split into two or more separate components, such as a north bridge and a south bridge, for example. Also, in some embodiments some or all of the functionality of I/O interface 630, such as an interface to system memory 620, may be incorporated directly into processor 610.

Network interface 640 may be configured to allow data to be exchanged between computer system 600 and other devices attached to a network (e.g., network 400), such as other computer systems, or between nodes of computer system 600. In various embodiments, network interface 640 may support communication via wired or wireless general data networks, such as any suitable type of Ethernet network, for example; via telecommunications/telephony networks such as analog voice networks or digital fiber communications networks; via storage area networks such as Fibre Channel SANs, or via any other suitable type of network and/or protocol.

Input/output devices 650 may, in some embodiments, include one or more display terminals, keyboards, keypads, touchpads, scanning devices, voice or optical recognition devices, or any other devices suitable for entering or accessing data by one or more computer systems 600. Multiple input/output devices 650 may be present in computer system 600 or may be distributed on various nodes of computer system 600. In some embodiments, similar input/output devices may be separate from computer system 600 and may interact with one or more nodes of computer system 600 through a wired or wireless connection, such as over network interface 640.

In some embodiments, the illustrated computer system may implement any of the methods described above, such as the method illustrated by FIGS. 2-3. In other embodiments, different elements and data may be included.

Those skilled in the art will appreciate that computer system 600 is merely illustrative and is not intended to limit the scope of embodiments. In particular, the computer system and devices may include any combination of hardware or software that can perform the indicated functions, including computers, network devices, Internet appliances, PDAs, wireless phones, pagers, etc. Computer system 600 may also be connected to other devices that are not illustrated, or instead may operate as a stand-alone system. In addition, the functionality provided by the illustrated components may in some embodiments be combined in fewer components or distributed in additional components. Similarly, in some embodiments, the functionality of some of the illustrated components may not be provided and/or other additional functionality may be available.

Those skilled in the art will also appreciate that, while various items are illustrated as being stored in memory or on storage while being used, these items or portions of them may be transferred between memory and other storage devices for purposes of memory management and data integrity. Alternatively, in other embodiments some or all of the software components may execute in memory on another device and communicate with the illustrated computer system via inter-computer communication. Some or all of the system components or data structures may also be stored (e.g., as instructions or structured data) on a computer-accessible medium or a portable article to be read by an appropriate drive, various examples of which are described above. In some embodiments, instructions stored on a computer-accessible medium separate from computer system 600 may be transmitted to computer system 600 via transmission media or signals such as electrical, electromagnetic, or digital signals, conveyed via a communication medium such as a network and/or a wireless link. Various embodiments may further include receiving, sending or storing instructions and/or data implemented in accordance with the foregoing description upon a computer-accessible medium. Accordingly, the embodiments described herein may be practiced with other computer system configurations.

Various embodiments may further include receiving, sending or storing instructions and/or data implemented in accordance with the foregoing description upon a computer-accessible medium. Generally speaking, a computer-accessible medium may include a storage medium or memory medium such as magnetic or optical media, e.g., disk or DVD/CD-ROM, volatile or non-volatile media such as RAM (e.g. SDRAM, DDR, RDRAM, SRAM, etc.), ROM, etc. In some embodiments, a computer-accessible medium may include transmission media or signals such as electrical, electromagnetic, or digital signals, conveyed via a communication medium such as network and/or a wireless link.

The methods described herein may be implemented in software, hardware, or a combination thereof, in different embodiments. In addition, the order of methods may be changed, and various elements may be added, reordered, combined, omitted, modified, etc. Various modifications and changes may be made as would be obvious to a person skilled in the art having the benefit of this disclosure. Realizations in accordance with embodiments have been described in the context of particular embodiments. These embodiments are meant to be illustrative and not limiting. Many variations, modifications, additions, and improvements are possible. Accordingly, plural instances may be provided for components described herein as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component. These and other variations, modifications, additions, and improvements may fall within the scope of embodiments as defined in the claims that follow.

1. A computer-implemented method, comprising:
receiving protected content on a computer system, the computer system accessible to a user;
receiving, at the computer system, a delegation token provided by a first entity, wherein receipt of the delegation token indicates the first entity determined the user is authorized to consume said protected content, wherein the delegation token is applicable for providing access to said protected content and additional protected content;
receiving, at the computer system, a content license for the protected content from a second entity, wherein said second entity operates under the control of an entity distinct from the first entity;
in response to receiving both the delegation token and the content license at the computer system, providing access to the protected content on the computer system.

2. The computer-implemented method of claim 1, wherein receipt of the delegation token indicates the first entity determined the user engaged in one or more of: a purchase of said protected content, a rental of said protected content, and a subscription to said protected content.

3. The computer-implemented method of claim 1, wherein providing access to the protected content comprises providing access to the protected content in accordance with one or more usage rules.

4. The computer-implemented method of claim 3, wherein said one or more usage rules comprise at least one rule for one or more of: restricting access to the protected content to a particular time period, restricting viewing of the protected content, restricting copying of the protected content, and restricting the distribution of the protected content.

5. The computer-implemented method of claim 1, wherein said receiving the protected content comprises receiving the protected content from a content distribution network (CDN).

6. The computer-implemented method of claim 1, wherein the method comprises:
prior to receiving said content license, submitting a request for that content license to the second entity, the request including the delegation token.

7. The computer-implemented method of claim 6, further comprising:
submitting a request for a second content license for the additional protected content, wherein the request for a second content license comprises the same delegation token received from the first entity;
receiving the second content license; and
providing access to the additional protected content in accordance with the received second content license.

8. The computer-implemented method of claim 1, further comprising:
subsequent to determining that the delegation token has expired, receiving a new delegation token; and
providing access to the protected content in response to receiving the content license and the new delegation token.

9. The computer-implemented method of claim 1, wherein at least a portion of the received content license is encrypted with a public key that corresponds to a private key within the received delegation token, wherein the method comprises decrypting said at least a portion of the received content license with said private key.

10. The computer-implemented method of claim 1, wherein the delegation token and the content license are part of a common license chain; wherein the delegation token is a root license of said license chain, wherein the content license is a leaf license of said license chain that includes a pointer to said delegation token.

11. The computer-implemented method of claim 10, wherein the method comprises receiving the content license prior to receiving the delegation token.

12. The computer-implemented method of claim 1, wherein said computer system comprises multiple runtime components for performing different processing tasks, wherein one of said multiple runtime components controls processing of the delegation token and an other one of said multiple runtime component controls processing of the content license.

13-16. (canceled)

17. A system, comprising:
a memory; and
one or more processors coupled to the memory, wherein the memory comprises program instructions executable by the one or more processors to:
receive protected content on said system, the system accessible to a user;
receive on said system a delegation token provided by a first entity, wherein receipt of the delegation token indicates the first entity determined the user is authorized to consume said protected content, wherein the delegation token is applicable for providing access to said protected content and additional protected content;
receive on said system a content license for the protected content from a second entity, wherein said second entity operates under the control of an entity distinct from the first entity;
in response to receiving both the delegation token and the content license on said system, provide access to the protected content on said system.

18. The system of claim 17, wherein receipt of the delegation token indicates the first entity determined the user engaged in one or more of: a purchase of said protected content, a rental of said protected content, and a subscription to said protected content

19. The system of claim 17, wherein to provide access to the protected content the program instructions are configured to provide access to the protected content in accordance with one or more usage rules.

20. The system of claim 19, wherein said one or more usage rules comprise at least one rule for one or more of: restricting access to the protected content to a particular time period, restricting viewing of the protected content, restricting copying of the protected content, and restricting the distribution of the protected content.

21. The system of claim 17, wherein to receive the protected content the program instructions are configured to receive the protected content from a content distribution network (CDN).

22. The system of claim 17, wherein the program instructions are configured to:
prior to receiving said content license, submit a request for that content license to the second entity, the request including the delegation token.

23. The system of claim 22, wherein the program instructions are configured to:
submit a request for a second content license for the additional protected content, wherein the request for a second content license comprises the same delegation token received from the first entity;
receive the second content license; and
provide access to the additional protected content in accordance with the received second content license.

24. The system of claim 17, wherein the program instructions are configured to:
subsequent to determining that the delegation token has expired, receive a new delegation token; and
provide access to the protected content in response to receiving the content license and the new delegation token.

25. The system of claim 17, wherein at least a portion of the received content license is encrypted with a public key that corresponds to a private key within the received delegation token, wherein the program instructions are configured to decrypt said at least a portion of the received content license with said private key.

26. The system of claim 17, wherein the delegation token and the content license are part of a common license chain; wherein the delegation token is a root license of said license chain, wherein the content license is a leaf license of said license chain that includes a pointer to said delegation token.

27. The system of claim 26, wherein the program instructions are configured to receive the content license prior to receiving the delegation token.

28. The system of claim 17, wherein the system comprises multiple runtime components configured to perform different processing tasks, wherein one of said multiple runtime components controls processing of the delegation token and an other one of said multiple runtime component controls processing of the content license.

29-32. (canceled)

33. A computer-readable storage medium, storing program instructions computer-executable on a computer system to:
receive protected content on said computer system, the computer system accessible to a user;
receive on said computer system a delegation token provided by a first entity, wherein receipt of the delegation token indicates the first entity determined the user is authorized to consume said protected content wherein the delegation token is applicable for providing access to said protected content and additional protected content;
receive on said computer system a content license for the protected content from a second entity, wherein said second entity operates under the control of an entity distinct from the first entity;
in response to receiving both the delegation token and the content license on said computer system, provide access to the protected content on said computer system.

34. The medium of claim 33, wherein receipt of the delegation token indicates the first entity determined the user engaged in one or more of: a purchase of said protected content, a rental of said protected content, and a subscription to said protected content

35. The medium of claim 33, wherein to provide access to the protected content the program instructions are configured to provide access to the protected content in accordance with one or more usage rules.

36. The medium of claim 35, wherein said one or more usage rules comprise at least one rule for one or more of: restricting access to the protected content to a particular time period, restricting viewing of the protected content, restricting copying of the protected content, and restricting the distribution of the protected content.

37. The medium of claim 33, wherein to receive the protected content the program instructions are configured to receive the protected content from a content distribution network (CDN).

38. The medium of claim 33, wherein the program instructions are configured to:
prior to receiving said content license, submit a request for that content license to the second entity, the request including the delegation token.

39. The medium of claim 38, wherein the program instructions are configured to:
submit a request for a second content license for the additional protected content, wherein the request for a second content license comprises the same delegation token received from the first entity;
receive the second content license; and
provide access to the additional protected content in accordance with the received second content license.

40. The medium of claim 33, wherein the program instructions are configured to:
subsequent to determining that the delegation token has expired, receive a new delegation token; and
provide access to the protected content in response to receiving the content license and the new delegation token.

41. The medium of claim 33, wherein at least a portion of the received content license is encrypted with a public key that corresponds to a private key within the received delegation token, wherein the program instructions are configured to decrypt said at least a portion of the received content license with said private key.

42. The medium of claim 33, wherein the delegation token and the content license are part of a common license chain; wherein the delegation token is a root license of said license chain, wherein the content license is a leaf license of said license chain that includes a pointer to said delegation token.

43. The medium of claim 42, wherein the program instructions are configured to receive the content license prior to receiving the delegation token.

44. The medium of claim 33, wherein the program instructions are configured to implement multiple runtime components configured to perform different processing tasks, wherein one of said multiple runtime components controls processing of the delegation token and an other one of said multiple runtime component controls processing of the content license.

45-49. (canceled)
